(19) United States
(12) Patent Application Publication
(10) Pub. No.: US 2006/0099132 A1
(43) Pub. Date: May 11, 2006

(54) Process for the production of precipitated calcium carbonates and product produced thereby

(76) Inventor: Gerald Dean Erdman, Pennsylvania, PA (US)

Correspondence Address: Michael J Herman;Minerals Technologies Inc, One Highland Avenue, Bethlehem, PA, 18017, US

(21) Appl. No.: 10/526,342

(22) PCT Filed: Jun. 18, 2002
(86) PCT No.: PCT/US02/19263

§ 371 Date: Mar. 2, 2005

(51) Int. Cl. C01F 11/18

(52) U.S. Cl. 423/432

(57) ABSTRACT

A process for producing precipitated calcium carbonate, including the steps of providing calcium hydroxyde, and carbonating the calcium hydroxyde with carbon dioxyde gas and communicating for a time sufficient to produce a calcium carbonate having at least about a 90 weight percent conversion to calcium carbonate and having a solids concentration of at least about 90 weight percent. Also, a process for producing precipitated calcium carbonate, including the steps of providing calcium hydroxide, carbonating the calcium hydroxide with carbon dioxide gas for a time sufficient to at least partially convert the calcium hydroxide to calcium carbonate, comminuting the at least partially converted calcium hydroxide, and sequentially repeating steps of carbonating and comminuting for a time sufficient to substantially convert the calcium hydroxide to calcium carbonate having at least about a 90 weight percent conversion to calcium carbonate and having a solids concentration of at least about 90 weight percent.

### FIELD OF THE INVENTION

The present invention relates generally to a process for producing a precipitated calcium carbonate (PCC) and a product produced using the process. More specifically, the process of the present invention produces high-solids precipitated calcium carbonates that can be manufactured starting with lime or calcium hydroxide and adding sufficient water to produce a precipitated calcium carbonate (PCC) product containing a maximum of about 10 weight percent water without a filtering or drying step.

The calcium carbonate particles produced according to the method of the present invention are particularly useful as fillers for paper as pigments for coated paper, as pigments for paints, as impact modifiers in polymers and may find specific application in the food, nutrition, cosmetic, and pharmaceutical industries.

### BACKGROUND OF THE INVENTION

Precipitated calcium carbonate (PCC) is manufactured via a series of controlled chemical reactions. Precipitated calcium carbonate (PCC) is commonly prepared by first slaking lime (CaO), commonly referred to as quicklime, by mixing with water to form an aqueous slurry of calcium hydroxide (“milk of lime”). This slurry is then reacted with carbon dioxide gas to precipitate calcium carbonate. The aragonite form of precipitated calcium carbonate (PCC) has an orthorhombohedral shape that crystallizes as long, thin needles that when manufacturing PCC using the gas-slurry process described above, however, the result is a low-solids slurry containing from about 10 weight percent to about 30 weight percent PCC which must be dewatered by mechanical, thermal, and/or other drying means known in the art to produce a high solids PCC. Because precipitated calcium carbonate (PCC) produced by the method described by the present invention contains at least about 90 weight percent solids, this method requires smaller vessels and less energy than a process that produces 10-30 weight percent precipitated calcium carbonate PCC.

Thus, the manufacture of high-solids PCC requires significant capital and energy, in addition to time, equipment, and labor costs, in order to increase the solids concentration of the as-produced PCC from gas-slurry processes.

### RELATED ART

International patent application WO 00/34182 teaches methods of treating lime, particularly carbide lime, containing insoluble impurities using an aqueous solution of a polyhydroxy compound to extract calcium ions from the lime to achieve a higher solubility of lime in solution than using water alone. After removing insoluble impurities, a purified solution of calcium ions remains that may be used for the production of calcium containing products.

U.S. Pat. No. 3,150,926 teaches a process for producing calcium carbonate by carbonating a mechanically fluidized bed of lime, either in its oxide or hydrated form, to which an excess of water has been added. The excess water is necessary to maintain the temperature sufficiently low to prevent overheating and consequent agglomeration or fusing during the exothermic hydration and carbonation stages. During hydration the temperature is preferably maintained in the range of 125 Fahrenheit to 220 Fahrenheit. When lime, such as that prepared by calcining limestone, is used as the starting material, various crushing, pulverizing and screening steps are performed prior to hydration.

European Patent No. 0912238 teaches a process for producing inorganic and organic powders by precipitation from a liquid reaction mixture. The process includes passing along a tubular reactor a segmented reaction flow comprised of discrete volumes of a reaction mixture separated by discrete volumes of a separating fluid which is substantially immiscible with the reaction mixture. The process is particularly useful in the preparation of oxalates, sulfides, and mixed sulfides. Additional possibilities include the synthesis of oxides, mixed oxides, carbonates, mixed carbonates, hydroxides, and hydroxycarbonates by precipitation or co-precipitation in aqueous or alcoholic media in the presence of urea which is heated to generate a precipitating anion.

### SUMMARY OF THE INVENTION

A process is provided for producing precipitated calcium carbonate, including the steps of providing calcium hydroxide, and carbonating the calcium hydroxide with carbon dioxide gas and comminuting, which is a milling action that exposes the unreacted calcium hydroxide allowing it to contact and react with the carbon dioxide gas stream to produce a calcium carbonate having at least from about 90 weight percent conversion of the calcium hydroxide feed to calcium carbonate and having a solids concentration of at least about 90 weight percent.

Also provided is a process for producing precipitated calcium carbonate, including the steps of providing calcium hydroxide, reacting the calcium hydroxide with carbon dioxide gas to produce a calcium hydroxide/calcium carbonate mixture, comminuting this mixture, and sequentially repeating the steps of reacting the calcium hydroxide with carbon dioxide gas and comminuting the calcium hydroxide/calcium carbonate mixture until this mixture is substantially converted to at least about 90 weight percent calcium carbonate having a solids concentration of at least about 90 weight percent.

### DETAILED DESCRIPTION OF THE INVENTION

The present invention provides a process for the preparation of at least about 90 weight percent precipitated calcium carbonate (PCC). Typical moisture ranges of the as-produced materials generated by this process are, preferably, from about 3 weight percent to about 10 weight percent using no filtering or drying steps. The method requires reacting calcium hydroxide that is either purchased or produced from lime with carbon dioxide gas to directly synthesize precipitated calcium carbonate (PCC) of at least about 90 weight percent solids without filtering or drying. More specifically, according to the process of the present invention a hydrated lime feed is reacted with a carbon dioxide gas stream and, either simultaneously or alternately, comminuted to produce at least about 90 weight percent precipitated calcium carbonate (PCC). Hydrated lime is calcium hydroxide made by reacting lime with water. Hydrated lime can be produced from commercially available limes or purchased as a raw material. The process of the present invention produces a high-solids PCC having a solids concentration of at least about 90 weight percent based on the total weight of the product.

### SLAKNG

Slaking, as defined here, means to react lime with water to produce calcium hydroxide and/or adjusting calcium hydroxide to a maximum of about 10 weight percent moisture. Preferably, the hydrated lime solids concentration is above about 90 weight percent and, most preferably, between about 90 weight percent to about 92 weight percent. This hydrated lime feed solids concentration produces slaking temperatures of up to 600 degrees Fahrenheit (315 degrees Celsius), while also providing enough water for carbonation to ultimately provide, with comminution, a product of at least about 90 weight percent precipitated calcium carbonate (PCC).

The slaking is most preferably conducted to produce about 92 weight percent slake solids at a temperature of up to about 600 degrees Fahrenheit (315 degrees Celsius). Slaking is continued until conversion to a hydrated lime having a high-solids content is substantially complete, preferably, being terminated when at least 90 percent conversion to calcium hydroxide having a solids content of from about 90 weight percent to about 97 weight percent, and most preferably, about 92 weight percent solids. For example, when mixing from about 50 pounds of water with about 75 pounds of lime, slaking is usually accomplished in a period of about 30 minutes to about 60 minutes to produce about 95-100 pounds hydrated lime having from about 90 to about 97 weight percent solids.

### CARBONATION AND COMMINUTION

The calcium hydroxide contained in the hydrated lime is then subjected to carbonation by reacting it with carbon dioxide gas to produce precipitated calcium carbonate. Unlike conventional slurry processes for the production of PCC, the carbonation step according to the present invention does not require any cooling of the carbon dioxide gas. The nature of the carbon dioxide gas for the carbonation is not particularly critical, the standard mixtures of carbon dioxide in either nitrogen or air as found in wet-scrubbed gases being satisfactory although pure carbon dioxide gas or liquid carbon dioxide can be used. The carbonation of the hydrated lime is continued until the conversion to calcium carbonate is at least about 90 weight percent, i.e., from calcium hydroxide to precipitated calcium carbonate (PCC). Preferably, water is added during carbonation to maintain the solids content of the mixture at approximately from about 90 to about 97 weight percent. Most preferably, water is added to maintain from about 90 weight percent to about 92 weight percent calcium hydroxide/calcium carbonate mixture solids concentration during carbonation.

According to the present invention, comminution occurring either simultaneously or alternately with the carbonation step is performed in order to expose the unreacted calcium hydroxide to achieve a high-degree of conversion to calcium carbonate during the carbonation reaction. As used herein, the term “comminution” means any process that shatters, cracks, fractures, breaks, or otherwise exposes the calcium hydroxide component of the material being processed and includes, but is not limited to, any milling, grinding, or pulverizing step for accomplishing the same.

When comminution is to be performed alternately with carbonation, the carbonation reaction may be performed using a pressurized vessel such as for example, a pipe pressurized to 40 pounds per square inch with carbon dioxide gas, to achieve, typically, greater than a 90 percent conversion of calcium hydroxide to calcium carbonate. The resultant calcium carbonate/hydrated lime mixture is then sequentially milled by removing it from the pressurized pipe and, in the case of small batches, by hand milling the mixture using a mortar and pestle, coffee grinder, or other such like device. The mixture is again charged to the pressurized pipe, subjected to carbonation, removed, and milled with these steps being sequentially repeated until conversion to calcium carbonate is at least about 90 weight percent. This method of repeatedly carbonating and comminuting in sequential steps demonstrated a conversion to calcium carbonate of at least about 90 weight percent.

Comminution may also be performed simultaneously with carbonation. Comminuting apparatus useful in performing this simultaneous reaction can be a tumbler or ball mill that incorporates comminuting media of various diameters and weights for milling/agitation during the reaction. An alternative apparatus useful in performing a continuous batch reaction is a mixer that has been retrofitted with a carbon dioxide gas supply and uses both comminuting media and, preferably, also incorporates a rotating scraping blade to prevent caking of the material against the mixer wall during processing, thereby providing more thorough comminution. Regardless of the comminution apparatus utilized, the requisite degree of comminution is that needed to repeatedly expose the interior of the unreacted hydrated lime feed to permit its conversion to calcium carbonate during carbonation. By varying the media loads, operating times, carbon dioxide gas concentrations, carbon dioxide gas rates, or any combination of these factors, the degree of comminution can be adjusted to achieve exposure and conversion of the unreacted hydrated lime feed. The PCC conversion achieved using this simultaneous carbonation and comminution accomplishes virtually complete conversion to a high-solids precipitated calcium carbonate product as described in greater detail below.

The as-produced precipitated calcium carbonate may be utilized as such for fillers, dry coating applications, and plastics-production additives. The as-produced precipitated calcium carbonate having high-solids may also be packaged and delivered to end-users for use in filling and coating applications. Alternatively, further finishing steps may be performed on the as-produced precipitated calcium carbonate to remove remaining inerts, such as, for example, magnesium and silica-containing compounds, in order to produce high purity PCC's useful in the production of paints, plastics, and healthcare products.

### SPECIFIC EXAMPLES AND TABLES

The following non-limiting examples are provided to more specifically teach and set forth particular embodiments of the present invention as envisioned here. They are for illustrative purposes only, however, and are not to be construed as limiting the invention. It is recognized that minor changes and alterations, such as for example a high-intensity media mill in conjunction with a concentrated carbon dioxide gas source, can be made to the process parameters and components that are not specifically contemplated herein. However, to the extent any such changes or alterations do not materially change or affect the process or the final product, it is to be understood that such changes also fall within the spirit and scope of the invention as defined by the claims that follow.

### STARTING FEED MATERIALS AND SLAKING PROCESS

Starting feed materials used to produce precipitated calcium carbonates according to the present invention were both hydrated lime having calcium hydroxide as the major component produced by slaking commercially available lime sources (Hydrates 1 and 2) and hydrated limes that are commercially available (Hydrates 3 and 4), the chemical compositions for which are listed below in Table 1.

TABLE 1
STARTING FEED MATERIALS

| | Hydrate from | Hydrate from | Mississippi | |
|---|---|---|---|---|
| | Mississippi | Beachville | MR200 Rotary | Mississippi Vertical |
| | Commercial | Commercial | Commercial | Codex Commercial |
| | Lime | Lime | Hydrate | Hydrate |
| | (Hydrate 1) | (Hydrate 2) | (Hydrate 3) | (Hydrate 4) |
| | XRF DATA - X-Ray Fluorescence Analysis | | | |
| CaO (weight percent) | 73.46 | 73.93 | 74.65 | 74.81 |
| LOI (weight percent) | 24.96 | 24.79 | 24.27 | 24.25 |
| SiO₂ (weight percent) | 0.94 | 0.42 | 0.54 | 0.53 |
| MgO (weight percent) | 0.62 | 0.78 | 0.41 | 0.37 |
| TOTAL | 99.98 | 99.92 | 99.87 | 99.96 |
| | TGA/DTA DATA - Thermal Analysis | | | |
| Ca(OH)₂ (weight percent) | 92.0 | 94.0 | 94.0 | 94.5 |
| CaCO₃ (weight percent) | 4.5 | 2.5 | 2.5 | 1.5 |
| Free H₂O (weight percent) | 0.6 | 0.5 | 0.6 | 0.7 |
| Misc. Losses (weight | 0.4 | 0.4 | 0.2 | 0.3 |
| percent) | | | | |
| Mg/Si/Al/Fe (weight | 1.71 | 1.37 | 1.12 | 1.05 |
| percent) | | | | |
| TOTAL | 99.21 | 98.77 | 98.42 | 98.05 |
| Possible CaO(weight | 1.32 | 1.39 | 2.11 | 2.46 |
| percent) | | | | |
| | TRACE ELEMENTS (χ 20 ppm) | | | |
| Al | 320 | 258 | 389 | 329 |
| Fe | 341 | 432 | 445 | 258 |
| K | 29 | 104 | 49 | 22 |
| Mg | 2370 | 3470 | 1730 | 1520 |
| Mn | — | 63 | — | — |
| Na | 123 | 118 | 124 | 121 |
| P | 48 | — | 51 | 39 |
| Si | 1700 | 1010 | 1970 | 2350 |
| Sr | 166 | 154 | 168 | 177 |
| Ti | — | — | — | 22 |
| V | — | — | 24 | — |
| Zn | — | 22 | — | — |

The Mississippi lime and hydrate materials referred to above are available from the Mississippi Lime Company, Ste. Genevieve, Mo., and the Beachville lime materials referred to above are available from Carmeuse Group North America, Beachville Plant, Ingersoll, Ontario, Canada. The hydrates identified above in Table 1 as Hydrates 1 and 2, respectively, were produced by slaking Mississippi and Beachville commercial limes. The Mississippi and Beachville limes having chemical compositions set forth in Table 1 above were slaked with water in a weight ratio of approximately 0.7 pounds of water per pound of lime. More specifically, to produce Hydrate 1, 75 pounds of lime was slaked by adding 53.1 pounds of water at 68 degrees Fahrenheit (20 degrees Celsius) over a period of 32 minutes to permit the exothermic slaking reaction to reach a reaction temperature up to about 600 degrees Fahrenheit (316 degrees Celsius). This elevated temperature was maintained below where calcium hydroxide decomposition occurs, approximately at about 600 degrees Fahrenheit (316 degrees Celsius), and then lowered to below 200 degrees Fahrenheit (93 degrees Celsius) when complete. The temperature profile of the slaking process is set forth below in Table 2:

TABLE 2
SLAKING TEMPERATURE PROFILE

| | Slaker Temperature | |
|---|---|---|
| Minutes into Hydration | Degrees Fahrenheit | Degrees Celsius |
| 0 | 68° F. | (20° C.) |
| 3 | 212° F. | (100° C.) |
| 16 | 476° F. | (247° C.) |
| 32 | 122° F. | (50° C.) |

This slaking process described above was repeated using Beachville commercial lime starting feed to produce Hydrate 2 having the properties set forth in Table 1 above.

### EXAMPLE SET 1 ALTERNATE CARBONATION AND COMMINUTION

In order to investigate the effect of high-pressure carbon dioxide gas during these experiments, calcium hydroxide was charged to a sealed pipe and the pipe was raised to 40 pounds per square inch using high-pressured carbon dioxide gas. The pipe's contents were allowed to react for about five (5) minutes, the vessel was then depressurized and the material from the pipe was analyzed.

Results showed that approximately about 10 weight percent conversion to precipitated calcium carbonate (PCC) had occurred. This mixture was subsequently hand-milled using a mortar pestle and/or a coffee grinder and recharged to the pipe where it was re-pressurized to 40 pounds per square inch with carbon dioxide gas and allowed to react for an additional five (5) minutes. The mixture was dumped from the pipe and re-analyzed and it was observed that approximately about an additional 10 weight percent conversion to precipitated calcium carbonate (PCC) had occurred. This finding indicated that comminution was a critical element for sustaining conversion of the calcium hydroxide/PCC mixture. Table 3 shows various examples where the mixture conversion to at least greater than about 96.6 weight percent precipitated calcium carbonate (PCC) occurred using this method.

TABLE 3
PRESSURIZED PIPE CONFIGURATION

| | SAMPLE NO. | | |
|---|---|---|---|
| | 1 | 2 | 3 |
| Hydrate Feed | Hydrate 1 | Hydrate 1 | Hydrate 1 |
| Percent Solids | 91.9 percent | 92.2 percent | 92.4 percent |
| Charge Weight | 50 grams | 150 grams | 100 grams |
| Run Conditions | | | |
| Concentration | 100 percent at | 100 percent at | 100 percent at |
| Carbon Dioxide Gas | 40 pounds per | 40 pounds per | 40 pounds per |
| (volume percent) | square inch | square inch | square inch |
| Number of Runs × | 10 × 5 minutes | 17 × 5 minutes | 16 × 5 minutes |
| Carbonation Time | | | |
| (minute)/Run | | | |
| Comminution | Mortar and | Mortar and | Coffee |
| Apparatus | Pestle | Pestle | Grinder |
| Run Results | | | |
| Conversion (percent) | 98.5 percent | 99.0 percent | 96.6 percent |
| Solids (percent) | 94.5 percent | 93.0 percent | 97.6 percent |

The data in Table 3 demonstrate the high conversion rates to calcium carbonate achieved when using comminution sequentially with carbonation on a hydrated lime feed having high-solids, i.e., above 90 weight percent and most preferably between about 90 weight percent to 92 weight percent solids. More specifically, Sample No. 1 produced using a hydrated lime feed of 91.9 percent solids achieved a 98.5 percent conversion to calcium carbonate. Sample No. 2 produced using a hydrated lime feed of 92.2 percent solids achieved a 99.0 percent conversion to calcium carbonate. Sample No. 3 produced using a hydrated lime feed of 92.4 percent solids achieved a 96.6 percent conversion to calcium carbonate having 97.6 weight percent solids. Table 3 shows conversion of calcium hydroxide to precipitated calcium carbonate (PCC) of at least 96.6 weight percent can be achieved by comminuting calcium hydroxide feeds with carbonation including high-solids feeds.

### EXAMPLE SET 2 SIMULTANEOUS CARBONATION AND COMMINUTION

A tumbler was manufactured using a twelve-inch long, twelve-inch diameter pipe fitted with bolted flange-rings and endplates of approximately fourteen inches in diameter. Four equally spaced internal one quarter (¼) inch wide baffles were longitudinally mounted within the pipe. The endplates were provided with an inlet for a carbon dioxide gas feed supply and an outlet for vapor removal. The tumbler was charged with 300 grams of hydrated lime produced from Mississippi commercial lime (i.e., Hydrate 1 described above) and various diameters and loads of comminuting media except for a comparative example (Sample No. 4) with which no media was used.

The tumbler was placed on a laboratory twin-roll horizontal roller that rotated the tumbler at 25 revolutions per minute, which for this tumbler apparatus, approached the critical speed beyond which the comminuting media would not tumble but stick to the tumbler wall. During rotation, the tumbler was supplied with 3.46 cubic feet per minute at 14.5 volume percent carbon dioxide gas to perform the carbonation reaction simultaneously with the comminution to achieve conversion of the calcium hydroxide to PCC, the process parameters and properties for which are set forth in Table 4 below.

To evaluate the use of commercially available hydrated limes, Comparative Sample No. 12 and Sample No. 13 also were prepared in the tumbler, described above, using Vertical/Codex calcium hydrate (i.e., Hydrate 4, described above) having a chemical composition as set forth in Table 1 above, as the hydrated lime feed with the process parameters set forth below in Table 4.

TABLE 4
DATA FOR COMMINUTION USING TUMBLER

| | | Sample No. | | | | | | | | | |
|---|---|---|---|---|---|---|---|---|---|---|---|
| | | | | | | | | | | Comp | |
| | | Comp 4 | 5 | 6 | 7 | 8 | 9 | 10 | 11 | 12 | 13 |
| Hydrate Feed | | Hydrate 1 | Hydrate 1 | Hydrate 1 | Hydrate 1 | Hydrate 1 | Hydrate 1 | Hydrate 1 | Hydrate 1 | Hydrate 4 | Hydrate 4 |
| Percent Solids | | 94.8 | 94.8 | 94.8 | 94.7 | 91.7 | 91.7 | 91.7 | 91.7 | 99.4 | 93.4 |
| Charge Weight | | 300 | 300 | 300 | 300 | 300 | 300 | 300 | 300 | 300 | 300 |
| | | grams | grams | grams | grams | grams | grams | grams | grams | grams | grams |
| Media Charge | | | | | | | | | | | |
| ¾ | Weight | — | 7.58 | 7.58 | 7.58 | 7.58 | — | — | 7.58 | 7.58 | 7.58 |
| Inch | (pounds) | | | | | | | | | | |
| Volume (ml) | | — | 1800 | 1800 | 1800 | 1800 | — | — | 1800 | 1800 | 1800 |
| ½ | Weight | — | 6.61 | 11.61 | 6.61 | 6.61 | 6.61 | 6.61 | 6.61 | 6.61 | 6.61 |
| Inch | (pounds) | | | | | | | | | | |
| Volume (ml) | | — | 1540 | 2690 | 1540 | 1540 | 1540 | 1540 | 1540 | 1540 | 1540 |
| ¼ | Weight | — | — | — | — | — | 2.20 | 2.20 | 2.20 | 2.20 | 2.20 |
| Inch | (pounds) | | | | | | | | | | |

| | | | | | | | | | | |
|---|---|---|---|---|---|---|---|---|---|---|
| Volume (ml) | | | | | | | | | | |
| Run Conditions | | | | | | | | | | |
| Tumbler Speed | 25 | 25 | 35.3 | 25 | 25 | 25 | 8 | 25 | 25 | 25 |
| (rev. per minute) | | | | | | | | | | |
| Gas | 100 | 100 | 100 | 100 | 100 | 14.5 | 14.5 | 14.5 | 14.5 | 14.5 |
| Concentration | | | | | | | | | | |
| (volume percent) | | | | | | | | | | |
| Gas Rate | 0.5 | 0.5 | 0.5 | 0.5 | 0.5 | 3.46 | 3.46 | 3.46 | 3.46 | 3.46 |
| Cubic feet | | | | | | | | | | |
| per min. | | | | | | | | | | |
| Run Time (Min.) | 15 | 15 | 15 | 30 | 30 | 30 | 30 | 30 | 30 | 30 |
| Run Results | | | | | | | | | | |
| Conversion | 45.7 | 97.3 | 95.0 | 95.2 | 97.0 | 94.1 | 91.4 | 96.9 | 14.4 | 85.1 |
| (percent) | | | | | | | | | | |
| Weight (grams) | 341 | 375 | 406 | 397 | 339 | 310.0 | 386.3 | 381.9 | 207 | 410 |
| Solids (percent) | 92.6 | 89.5 | 89.2 | 90.8 | 90.5 | 91.2 | 91.0 | 90.9 | 97.7 | 93.7 |

The data in Table 4 demonstrate the high conversion rates to calcium carbonate achieved when using comminution simultaneously with carbonation on a hydrated lime feed having at least about 91 weight percent solids. More specifically, Sample Nos. 5-8 produced using carbon dioxide with a hydrate feed having from about 94.7 percent to about 94.8 percent solids achieved conversions of from about 95.0 percent to about 97.3 percent calcium carbonate with solids contents of about 90 weight percent. This is in comparison with a 45.7 percent conversion of

Comparative Sample 4 achieved using no comminuting media with a hydrate feed having 94.8 weight percent solids.

Sample Nos. 9-11 run using various media sizes and loads at 8 revolutions per minute and 25 revolutions per minute with a carbon dioxide gas provided at 3.46 cubic feet per minute at a concentration of 14.5 volume percent further illustrate the beneficial effect of increasing both the amount of media charge and tumbler speed to produce PCC having higher conversions. More specifically, when beginning with a hydrate charge of 91.7 weight percent solids, a tumbler speed of 8 revolutions per minute gave a lower conversion to PCC of about 91.4 percent (Sample 10) when compared to an increased conversion of about 94.1 percent (Sample 9) obtained using a tumbler speed of 25 revolutions per minute with the same amount of media charge. Upon further increasing the media charge with a tumbler speed of 25 revolutions per minute, about 96.9 percent conversion (Sample 11) was obtained. All three Samples 9-11 produced PCC solids of about 91 percent.

The data also show that commercially available hydrated limes may also be used as the feed for the process of the present invention when the hydrated lime is provided with water in amounts preferably approaching from about 8 weight percent to about 10 weight percent. Specifically, Comparative Sample No. 12 produced using a hydrated lime feed having about 99.4 weight percent solids yielding about a 14.4 weight percent conversion while Sample 13 having lower hydrated lime solids of about 93.4 weight percent exhibited a conversion to about 85.1 percent.

### EXAMPLE SET 3-SIMULTANEOUS CARBONATION AND COMMINUTION

A commercial-grade mortar mixer manufactured by Stow Co. Binghamton, N.Y., was retrofitted with a carbon dioxide gas supply line and water supply piping with water spray nozzles located inside the mortar mixer vessel for providing a water spray for temperature maintenance and dust control during carbonation. Hydrated lime feed and media were charged to the mixer and the unit agitated and gassed to complete the reaction. To help prevent caking of the mixture against the inside wall of the mortar mixer, rubber-tipped or stainless steel stationary wipers were also provided inside the mortar mixer to continuously scrape the wall during rotation of the mortar mixer vessel, as well as lift the media to generate the comminution required during the reaction step.

More specifically, the mortar mixer was charged with 16 pounds and 24 pounds of hydrated lime and 15-pounds, 25-pounds, and 50-pound loads of ¼-inch diameter comminuting media. Water was provided at rates to remove the heat generated by carbonation while maintaining the reaction at optimal solids concentration. A comparative example (Comparative Sample No. 14) was also run using 32 pounds of hydrated lime feed with no comminuting media. Carbon dioxide gas of concentrations from about 17.0 percent to about 17.8 percent and a flow rate of from about 14.2 cubic feet per minute were supplied at room temperature to the mixer for varying times of from about 75 minutes to about 120 minutes to produce high conversions of the slake to PCC of up to about 97.6 percent.

Samples 14-17 and 20-21 were produced using hydrated lime produced from Mississippi commercial lime (i.e., Hydrate 1, described above) while Sample 18 was produced using hydrated lime produced from Beachville commercial lime (i.e., Hydrate 2, described above) and Sample 19 was produced using Mississippi commercial hydrated lime (i.e., Hydrate 3, described above), the process parameters and properties for which are set forth in Table 5 below. Additionally, Samples 14-17 and 20 were produced using rubber-tipped wipers while Samples 18, 19, and 21 were produced using stainless steel wipers.

TABLE 5
DATA FOR COMMINUTION USING MORTAR MIXER

| | | Sample No. | | | | | | | |
|---|---|---|---|---|---|---|---|---|---|
| | | Comp | | | | | | | |
| | | 14 | 15 | 16 | 17 | 18 | 19 | 20 | 21 |
| Hydrate Feed | | Hydrate 1 | Hydrate 1 | Hydrate 1 | Hydrate 1 | Hydrate 1 | Hydrate 1 | Hydrate 1 | Hydrate 1 |
| Percent Solids | | 93.3 | 92.8 | 83.9 | 87.0 | 90.4 | 91.1 | 86.4 | 89.0 |
| Charge Weight | | 32 | 16 | 16 | 16 | 24 | 24 | 24 | 24 |
| (pounds) | | | | | | | | | |
| Media Charge | | | | | | | | | |
| ¼ | Weight | — | 15 | 15 | 15 | 25 | 25 | 50 | 50 |
| Inch | (pounds) | | | | | | | | |

| | | | | | | | | |
|---|---|---|---|---|---|---|---|---|
| Volume (ml) | — | 4086 | 4086 | 4086 | 6810 | 6810 | 13620 | 13620 |
| Run Conditions | | | | | | | | |
| Gas Concentration | 17.8 | 17.5 | 17.0 | 17.7 | 17.2 | 17.2 | 17.2 | 17.2 |
| (Volume percent) | | | | | | | | |
| Gas Rate (cubic | 14.2 | 14.2 | 14.2 | 14.2 | 14.2 | 14.2 | 14.2 | 14.2 |
| feet per minute) | | | | | | | | |
| Run Time (minute) | 105 | 120 | 120 | 120 | 86 | 75 | 90 | 90 |
| Run Results | | | | | | | | |
| Conversion | 88.1 | 92.2 | 92.7 | 96.6 | 97.0 | 96.3 | 97.6 | 96.4 |
| (percent) | | | | | | | | |
| Solids (percent) | 95.2 | 95.4 | 97.3 | 90.0 | 93.6 | 95.6 | 92.0 | 94.2 |

The data in Table 5 demonstrate the high conversion rates to precipitated calcium carbonate as high as about 98 percent achieved when using comminution simultaneously with carbonation on a hydrated lime feed having a range of solids, including hydrated lime feeds having higher solids contents i.e., above 90 weight percent. More specifically, Sample Nos. 15-21 produced using increasing media loads at a constant rotational speed with carbon dioxide gas provided at a constant rate (14.2 cubic feet per minute) and at a relatively constant concentration (17.0 volume percent to 17.7 volume percent) further illustrate the beneficial effect of increasing both the amount of media charge to produce PCC having higher conversions. More specifically, Samples 18-21 having increased media loads of 25 pounds and 50 pounds exhibit higher conversions to PCC (96.3 percent to 97.6 percent) than Comparative Sample 14 which used no media and yielded the lowest conversion of about 88 percent.

For media loads of 15 pounds of one quarter (¼) inch diameter media charges, Samples 15 and 17 show increasing conversion at lower final solids concentrations after run times of 120 minutes. For 25-pound media charges, Samples 18 and 19 show that maintaining lower solids increases conversion. Moreover, Samples 20 and 21 which used a batch size of 1.5 times that of Samples 15-17 with a media charge of more than three times higher (50 pounds., ¼″ diameter) show increasing conversion productivity at shorter gas times of 90 minutes verses 120 minutes. Moreover, Samples 17-21 having more media and/or lower final product moisture all have higher conversions than the no or low media cases of Samples 14-16.

Thus, the process according to the present invention produces a high-solids PCC having at least a 90 weight percent solids using a reaction step that requires minimal dewatering or drying thereby eliminating the need for large filters and dryers. By performing sufficient comminution either during the addition of carbon dioixide gas to calcium hydroxide or alternately adding carbon dioxide gas to calcium hydroxide followed by comminution and recharging with gas and repeating this cycle demonstrates that conversions to calcium carbonate of about 100 weight percent precipitated calcium carbonate (PCC) may be achieved. By eliminating the extensive drying steps typically performed for gas-slurry processes, the process of the present invention simplifies the process for producing PCC, thereby, providing low-cost PCC for use in fillers, coating-grade slurry applications, dry-coating applications, plastics-production additives, as well as for use in producing, with minimal additional finishing steps, PCC for paints, plastics, and healthcare products.

Using materials produced by the process according to the present invention (i.e., rather than a conventional slurry) as the starting feed for producing high solids PCC or further modified PCC products permits the use of small-scale equipment for post-processing while reducing storage and transportation requirements.

Moreover, unlike conventional PCC production processes that utilize slurries, the process provides significant additional operating advantages, among which are ability to use carbon dioxide gas supply without cooling, cutting water consumption and permitting the use of a low energy compressor to deliver the gas to this process. Additionally, the process according to the present invention reduces the wet-waste and disposal costs associated therewith while eliminating a majority of the water typically used for slaking.

While embodiments and application of this invention have been shown and described, it will be appreciated by those skilled in the art that modifications and embodiments are possible without departing from the inventive concepts herein described. For example, although embodiments are shown and described above with respect to specific gas-contacting and comminuting apparatus, it will be apparent to those skilled in the art that other similar devices may be employed to simultaneously or alternately expose the unreacted feed during carbonation to effect a high slake conversion according to the process of the present invention. Gas-contacting apparatus useful in this regard can include various commercially available mills that have been retrofitted with a gas supply to permit carbonation and comminution to be simultaneously performed. Exemplary comminuting apparatus in this regard include air classifying mills, hammer mills, jet-mills, pin mills, disc mills, colloid mills, agitated ball mills, sand mills or other mills known in the art.

Other materials handling devices such as blenders, conveyors, dryers, and other vessels that have been retrofitted with a gas supply may also be used as gas contactors for practicing the process according to the present invention. Exemplary blenders in this regard include single-cone, double-cone, “V”-cone, and continuous blenders, and cement mixers. Exemplary conveyors in this regard include single-screw or multiple screw conveyors that may also be provided in a helical-screw or fluted-shaft configuration. Exemplary dryers in this regard include spray, flash, rotary, tunnel, and tray dryers. Exemplary vessel configurations in this regard include those having a cylindrical, polygonal, oval, and spherical cross-sections. When used in combination with separate comminuting apparatus, these materials handling devices can be used to perform alternate carbonation steps as described in detail above. By providing and using comminuting media in these materials handling devices, carbonation and comminution can be performed simultaneously. Moreover, additional internal agitation (e.g., stirring blades, impellers, and internal baffles) may also be employed with blenders, dryers, and vessels where physically feasible to further enhance the carbonation reaction.

Moreover, although the examples shown and described above with respect to smaller batch processes using specific hydrated lime feeds, it will be apparent to those skilled in the art that these processes may be provided as full-scale batch or continuous reactions while using feeds from other lime or hydrated lime sources. Additional down-stream finishing steps including drying, classifying, milling, surface treatment, may also be employed to achieve the desired final product characteristics.

Therefore, it is intended that the appended claims cover all such modifications and embodiments that fall within the true spirit and scope of the present invention.

What is claimed is:

1. A process for producing precipitated calcium carbonate, comprising the steps of:
(a) providing calcium hydroxide; and
(b) carbonating the calcium hydroxide with carbon dioxide gas and comminuting for a time sufficient to produce a calcium carbonate having at least about a 90 weight percent conversion to calcium carbonate and having a solids concentration of at least about 90 weight percent.

2. The process according to claim 1, wherein the calcium hydroxide provided is at least about 90 weight percent solids with water present in an amount of up to about 10 weight percent.

3. The process according to claim 2, wherein the calcium hydroxide provided is about 92 weight percent solids.

4. The process for producing precipitated calcium carbonate according to claim 1, wherein the calcium hydroxide provided in step (a) is produced by the steps comprising:
i) mixing calcium oxide and water in amounts sufficient to react to form calcium hydroxide substantially free of water; and
ii) maintaining the mixture at an elevated temperature for a time sufficient to hydrate the calcium oxide to form calcium hydroxide having at least about 90 weight percent solids and water present in an amount of up to about 10 weight percent.

5. The process according to claim 4, wherein the step of maintaining the mixture at an elevated temperature is performed at a temperature of up to about 600 degrees Fahrenheit for a time sufficient to hydrate the calcium oxide to form calcium hydroxide having at least about a 95 weight percent conversion to calcium hydroxide.

6. The process according to claim 5, wherein the step of maintaining the mixture at an elevated temperature is performed for a time sufficient to hydrate the calcium oxide to form calcium hydroxide having at least about a 98 weight percent conversion to calcium hydroxide.

7. The process according to claim 1, wherein the steps of carbonating and comminuting are performed until at least a 95 weight percent conversion to calcium carbonate is achieved.

8. The process according to claim 1, wherein the steps of carbonating and comminuting are performed until at least a 97 weight percent conversion to calcium carbonate is achieved.

9. A process for producing precipitated calcium carbonate, comprising the steps of:
(a) providing calcium hydroxide;
(b) carbonating the calcium hydroxide with carbon dioxide gas for a time sufficient to at least partially convert the calcium hydroxide to calcium carbonate;
(c) comminuting the at least partially converted calcium hydroxide; and
(d) sequentially repeating steps of carbonating and comminuting for a time sufficient to substantially convert the calcium hydroxide to calcium carbonate having at least about a 90 weight percent conversion to calcium carbonate and having a solids concentration of at least about 90 weight percent.

10. The process according to claim 9, wherein the calcium hydroxide provided is at least about 90 weight percent solids with water present in an amount of up to about 10 weight percent.

11. The process according to claim 10, wherein the calcium hydroxide provided is about 92 weight percent solids.

12. The process for producing precipitated calcium carbonate according to claim 9, wherein the calcium hydroxide provided in step (a) is produced by the steps comprising:
i) mixing calcium oxide and water in amounts sufficient to react to form calcium hydroxide substantially free of water; and
ii) maintaining the mixture at an elevated temperature for a time sufficient to hydrate the calcium oxide to form calcium hydroxide having at least about 90 weight percent solids and water present in an amount of up to about 10 weight percent.

13. The process according to claim 12, wherein the step of maintaining the mixture at an elevated temperature is performed at a temperature of up to about 600 degrees Fahrenheit for a time sufficient to hydrate the calcium oxide to form calcium hydroxide having at least about a 95 weight percent conversion to calcium hydroxide.

14. The process according to claim 13, wherein the step of maintaining the mixture at an elevated temperature is performed for a time sufficient to hydrate the calcium oxide to form calcium hydroxide having at least about a 98 weight percent conversion to calcium hydroxide.

15. The process according to claim 9, wherein the steps of carbonating and comminuting are performed until at least a 95 weight percent conversion to calcium carbonate is achieved.

16. The process according to claim 15, wherein the steps of carbonating and comminuting are performed until at least a 97 weight percent conversion to calcium carbonate is achieved.

17. The calcium carbonate product produced-by-the-process of claim 1.

18. The calcium carbonate product produced-by-the-process of claim 4.

19. The calcium carbonate product produced-by-the-process of claim 9.

20. The calcium carbonate product produced-by-the-process of claim 12.
